(19) United States
(12) Patent Application Publication
(10) Pub. No.: US 2020/0316791 A1
(43) Pub. Date: Oct. 8, 2020

(54) Attachment System For Industrial Robot, Industrial Robot And Method

(71) Applicant: ABB Schweiz AG, Baden (CH)

(72) Inventor: Daniel Sirkett, Fjärdhundra (SE)

(21) Appl. No.: 16/956,896

(22) PCT Filed: Jan. 16, 2018
(86) PCT No.: PCT/EP2018/050966

§ 371 Date: Jun. 22, 2020

(51) Int. Cl. B25J 15/08; B25J 15/04

(52) U.S. Cl. CPC B25J 15/08; B25J 15/0491; B25J 15/0425; B25J 15/0475

(57) ABSTRACT

An attachment system for an industrial robot, the attachment system including a base member having a base and a locking member movable relative to the base between a locking position and an unlocking position; and an attachment member; wherein the attachment member includes an engageable structure configured to be engaged by the locking member when the locking member adopts the locking position, in order to fix the attachment member to the base member; and wherein the attachment system further includes an engaging biasing member configured to bias the locking member towards the engageable structure, when the locking member engages the engageable structure in the locking position. An industrial robot including an attachment system and a method for handling the industrial robot are also provided.

### TECHNICAL FIELD

The present disclosure generally relates to an attachment system for an industrial robot. In particular, an attachment system comprising a base member and an attachment member for detachable attachment to the base member, an industrial robot comprising the attachment system, and a method for handling the industrial robot, are provided.

### BACKGROUND

Some known industrial robots comprise one or more hands with gripping mechanisms having two gripper fingers for grasping an object. The gripper fingers may be replaced, for example in order to perform different tasks or due to wear of the gripper fingers. Known gripping mechanisms for industrial robots typically comprise two gripper fingers attached to the robot hand (e.g. to a standard finger mounting plate) by means of small screws. The task of replacing the gripper fingers is difficult and time consuming. There is a risk that screws are lost or damaged (for example due to cross threading or overtightening) in the replacement process and a risk that the replacing gripper finger is erroneously attached to the robot hand (for example with the wrong polarity). Most standard finger mounting plates of robot hands have a symmetric hole pattern which allows gripper fingers to be attached with incorrect polarity (for example upside down).

In order to avoid the above problems, a great deal of engineering effort is today carried out for designing gripper fingers having multiple grip features. The design of such gripper fingers having multiple grip features may not even be possible if the objects to be gripped differ too greatly in form or size. Consequently, the integration time is often increased, which may hinder the full flexibility potential of the industrial robot from being exploited.

Furthermore, some known industrial robots comprise robot hands having a hand shell that protrudes beyond the finger mounting plates. Great care must therefore be taken in order to ensure that no part of the gripper finger collides with the hand shell.

Furthermore, some known robot hands comprise two non collinear finger mounting plates (i.e. the finger mounting plates overlap rather than approach each other along a common path) and asymmetrical gripper fingers mounted to the finger mounting plates. This asymmetry of the gripper fingers introduces grasp force asymmetry since one gripper finger is necessarily longer and typically more flexible than the other gripper finger.

Furthermore, in some industrial robot applications, it is desirable that the industrial robot itself is capable of changing gripper fingers during operation, in order to allow objects of different shapes and sizes to be grasped.

U.S. Pat. No. 4,613,277 A discloses a robotic head that includes a pair of fingers that are adapted to be moved back and forth in parallel relationship between closed and open positions. In addition, the document provides a group of interchangeable fingertip sets, with each fingertip set being formed to retrieve and hold a certain size or shaped object. Each fingertip set can be automatically attached and detached from the fingers of the robotic head. At one single work station, the robotic head through appropriate programming can automatically interchange fingertip sets such that the same robotic head can retrieve and set various types and sizes of elements or parts at one single work station.

DE 102004029051 B3 discloses a gripper comprising two jaws and two fastening arrangements. The fastening arrangement comprises a locking bolt and two openings for receiving fastening bolts of the jaw. The locking bolt is rotatable about a central longitudinal axis between a first rotational position and a second rotational position. Each fastening bolt comprises a groove-like constriction.

JP 4238440 B2 discloses an article gripper comprising replaceable grip claws. The article gripper comprises, for each grip claw, a holding member comprising a lever and a block. A grip claw is attached to the lever by fastening a bolt into a screw hole of the lever.

US 2013245823 A1 discloses a finger holding mechanism which replaceably holds at least a pair of finger members. The finger holding mechanism comprises a pair of finger holding portions that are connected to a pair of pistons. Each finger holding portion comprises a link member rotatable between an engaged posture and a released posture. In the engaged posture, the link member engages the finger member, and in the released posture, the link member releases the engagement of the finger member. In the engaged posture, a protruding portion of the link member engages with a concave portion provided to a surface of the finger member.

WO 2008009828 A2 discloses an assembly device comprising a sheath, a bolt accommodated in a bore of the sheath, and a mandrel. The latch comprises a spring which holds the latch in an active locking position. The bolt comprises a protruding button for being pressed by an operator. The mandrel comprises a groove forming a shoulder. The shoulder interacts with a flat on the latch to immobilize the mandrel.

GB 2191466 A discloses a robot hand comprising a holding means and a releasable gripper. The holding means comprises a body. An actuator pin and a retaining pin are mounted in the body. A second end of the actuator pin is fixedly attached to a top of the retaining pin by a cross plate. The holding means further comprises a spring on a first end of the actuator pin. The spring acts between the body and a circlip on the end of the actuator pin to bias both the actuator pin and the retaining pin in a downwardly direction. The gripper comprises a locating arm that can fitted into a hole in a body.

### SUMMARY

One object of the present disclosure is to provide an attachment system for an industrial robot, which attachment system enables a fast, simple, accurate, fool proof and/or manual attachment and/or detachment (e.g. replacement) of an attachment member, in particular a gripper finger, of an industrial robot.

A further object of the present disclosure is to provide an attachment system for an industrial robot, which attachment system can be retrofitted to existing industrial robots, e.g. without modification of a robot hand of the industrial robot.

A still further object of the present disclosure is to provide an attachment system for an industrial robot, which attachment system enables both manual and automatic attachment and/or detachment of an attachment member, in particular a gripper finger, of an industrial robot.

A still further object of the present disclosure is to provide an attachment system for an industrial robot, which attachment system enables a simplification of the design of gripper fingers detachably attachable to a robot hand of an industrial robot.

A still further object of the present disclosure is to provide an attachment system for an industrial robot, which attachment system has an improved user experience.

A still further object of the present disclosure is to provide an industrial robot comprising an attachment system, which industrial robot solves one, several or all of the foregoing objects.

A still further object of the present disclosure is to provide a method for handling the industrial robot solving one, several or all of the foregoing objects.

According to one aspect, there is provided an attachment system for an industrial robot, the attachment system comprising a base member having a base and a locking member movable relative to the base between a locking position and an unlocking position; and an attachment member; wherein the attachment member comprises an engageable structure configured to be engaged by the locking member when the locking member adopts the locking position, in order to fix the attachment member to the base member; and wherein the attachment system further comprises an engaging biasing member configured to bias the locking member towards the engageable structure, when the locking member engages the engageable structure in the locking position.

Either the base member or the attachment member may comprise the engaging biasing member. Due to the biasing force of the locking member towards the engageable structure of the attachment member by means of the engaging biasing member, the attachment member is fixedly held in an attachment position. By moving the locking member from the locking position to the unlocking position, the attachment member may be removed (manually or automatically) from the base member. The attachment system may thus be referred to as a quick release mechanism or quick change system.

The attachment member may be fixedly held in the attachment position only by means of the engaging biasing member and the locking member, e.g. no additional screws may be needed. The engaging biasing member and the engageable structure may be designed such that a particular preload is applied on the attachment member against the base member when the locking member adopts the locking position. The engaging biasing member also biases the locking member towards the engageable structure of the attachment member such that accidental disengagement is prevented. The engageable structure may comprise a detent or seat in which the locking member can be seated when adopting the locking position. This further prevents accidental disengagement.

The attachment system may comprise a locking device having a central element, such as a cylindrical central element, and the locking member may be fixed to the central element. The central element may be constituted by a turret.

The attachment system may comprise a bayonet connector or bayonet mount comprising a male part and a female receptor. In this case, the locking member may constitute a radial pin of the male part and the engageable structure may correspond to a slot of the female receptor.

The base may be constituted by a mounting plate which may be referred to as an intermediate mounting plate due to its possible arrangement between the attachment member and an existing standard finger mounting plate. One or several engageable structures may be provided in the attachment member. The engaging biasing member may be constituted by an elastic element, such as a spring.

The locking member may be connected to the base such that the attachment member can be attached to the base member and detached from the base member without detaching the locking member from the base. Alternatively, or in addition, the engageable structure may be constituted by a cam profile. The engageable structure according to the present disclosure may comprise one, two or more cam profiles for being engaged by a locking member. According to one variant, the attachment system comprises one locking member arranged to simultaneously engage two cam profiles. Each cam profile may be constituted by a helical ramp.

According to one example, the base member comprises a base constituted by a mounting plate, a bayonet connector comprising the locking member and an engaging biasing member constituted by a spring. The engageable structure may comprise two helical ramps. The base member may thus constitute a spring loaded bayonet mechanism that engages with helical ramps on the removable attachment member.

The attachment member may comprise a releasing structure constituted by a through opening through which the locking member can pass when adopting the unlocking position, in order to attach the attachment member to the base member and in order to detach the attachment member from the base member. The releasing structure may comprise an oblong hole joined with a circular hole centrally disposed over the oblong hole. In case the locking member is constituted by a locking pin, the size of the oblong hole may correspond to the size of the locking pin. According to a possible alternative variant, the releasing structure is constituted by a triangular through hole and the locking member has a corresponding triangular appearance.

The movement of the locking member between the locking position and the unlocking position may comprise a rotational movement. The rotational movement of the locking member between the locking position and the unlocking position may for example be 60° to 120°, such as 90°, or approximately 90°. In case the base has an elongated appearance, e.g. constituted by a rectangular plate, the locking member may be substantially parallel with, or parallel with, a longitudinal axis of the base when the locking member adopts the unlocking position, and substantially perpendicular to, or perpendicular to, the longitudinal axis of the base (i.e. oriented substantially parallel with a lateral axis of the base) when the locking member adopts the locking position.

Alternative movements of the locking member between the locking position and the unlocking position are however conceivable. One alternative example includes a linear movement of the locking member along an engageable structure comprising a linear inclined profile. In this case, the attachment member may comprise a wedge-shaped portion.

The attachment system may further comprise a rotation biasing member arranged to rotationally bias the locking member towards the unlocking position. The rotation biasing member may be constituted by an elastic element, such as a torsion spring.

The attachment system may further comprise a gripper finger unit, wherein the gripper finger unit comprises a gripper finger and the attachment member. According to one variant, the gripper finger and the attachment member are integrally formed. Both the gripper finger and the attachment member may for example be 3D printed in one piece.

According to an alternative variant, the gripper finger unit comprises the attachment member and a gripper finger detachably attachable to the attachment member. In this case, the attachment member may comprise a mounting portion, such as a protruding tab, to which the gripper finger can be attached. The mounting portion may be positioned on one side of the attachment member, e.g. asymmetrically positioned on the attachment member along a longitudinal axis of the attachment member such that the attachment member has a generally L-shaped appearance. In this manner, it can be seen whether two attachment members of a gripper mechanism adopt an open configuration or a closed configuration on a robot hand even if the gripper fingers are removed. Alternatively, or in addition, the mounting portion may be asymmetrically positioned on the attachment member along a lateral axis of the base. In this manner, collinear movement of two gripper fingers can be achieved.

In variants where a gripper finger unit comprises an attachment member and a gripper finger detachably attachable to the attachment member, the attachment member may be made of metal and the gripper finger may be an application-specific part that may be 3D printed.

The attachment system according to the present disclosure may alternatively comprise an end effector other than a gripper finger unit, for example a probe or sensor.

The attachment system may further comprise a positioning arrangement configured to unambiguously define a rotational relationship between the base member and the attachment member in the attachment position of the attachment member. In other words, the positioning arrangement defines one, and only one, rotational relationship between the base member and the attachment member. An attachment of the attachment member with incorrect polarity (e.g. upside down with wrong rotational position) to the base member can thereby be avoided. The positioning arrangement may have an asymmetric design on the base member, e.g. as seen in a plane view of the base member. The positioning arrangement may comprise two openings in one of the base member and the attachment member and two positioning pins in the other of the base member and the attachment member for engaging the two openings.

The base member may be configured to be fastened to a finger mounting plate of a robot hand of an industrial robot. Thus, various industrial robots comprising a robot hand with two finger mounting plates may be retrofitted with the attachment system according to the present disclosure. The base member may however be provided on parts of the industrial robot other than a robot hand.

The attachment system may further comprise a tool configured to engage the locking member for manipulation of the locking member between the locking position and the unlocking position. The attachment system may further comprise at least one additional replacement gripper finger unit, wherein the at least one additional replacement gripper finger unit comprises an additional replacement gripper finger and an additional replacement attachment member. The attachment system may thus be manually operated by means of the tool and may consequently be referred to as a manual attachment system.

The attachment system may further comprise a holding device for releasably holding the attachment member, the holding device comprising a stationary support member comprising a longitudinal axis and at least one holding stop at one end of the support member; a holding member rotatably arranged on the support member for rotation about the longitudinal axis of the support member between a holding position and a releasing position; and a holding biasing member configured to bias the holding member towards the holding stop, such that a clamping interface for the attachment member is provided between the holding member and the holding stop, when the holding member adopts the holding position.

When the attachment member is clamped between the holding member and the holding stop by means of the holding biasing member, the attachment member can be held stably by the holding device in any orientation in space.

In this position, the attachment member is thus preloaded against the holding stop. The support member and the holding stop arranged on the support member may be stationary when the holding member rotates between the holding position and the releasing position.

The holding device according to the present disclosure is a passive device, i.e. it does not require any power for operation and it does not comprise any actuators for operation. The holding device may be operated by movement of the robot hand of the industrial robot to which the attachment member is attached. Alternatively, or in addition, the holding device may be operated by manual movement of an attachment member according to the present disclosure. The holding device enables releasable holding of a detached attachment member of an industrial robot in a simple and reliable manner.

The holding device may be constituted by a pillar in which the support member is arranged. One end of one or more pillars may for example be secured to a support base or directly to the industrial robot. The holding member may be arranged in the opposite end of the pillar. The pillars may be oriented arbitrarily in space.

Throughout the present disclosure the support member may be elongated and for example constituted by a stationary shaft or rod. The support member may for example be fixed to a stationary socket which in turn is fixed to a base plate. The holding member may for example be constituted by a location block. The at least one holding stop may protrude substantially perpendicular to, or perpendicular to, the longitudinal axis of the support member.

The at least one holding stop may be constituted by two holding stops, wherein each holding stop protrudes in substantially opposite directions, or in opposite directions, perpendicular to the longitudinal axis of the support member and wherein a longitudinal axis of the holding member is substantially aligned with the two holding stops in the releasing position. A longitudinal axis of the holding member may be substantially perpendicular to, or perpendicular to, the two holding stops in the holding position. The angular range of the holding member between the holding position and the releasing position may for example be 90° about the longitudinal axis of the support member.

The support member may comprise a tubular portion comprising the two holding stops. In this case, the tubular portion may comprise two receiving slots for receiving a locking pin in a direction substantially parallel with, or parallel with, the longitudinal axis of the support member. A longitudinal axis of the holding member may be substantially aligned with, or aligned with, the two receiving slots in the holding position. The longitudinal axis of the holding member may be substantially perpendicular to, or perpendicular to, the two receiving slots in the releasing position.

The two receiving slots constitute one example of a stationary engaging structure according to the present disclosure. The two receiving slots may be formed as cutouts in the tubular portion facing away from the holding device in directions parallel with the longitudinal axis of the support member.

The holding device may further comprise a blocking pin fixed to the support member and protruding from the support member substantially perpendicular to, or perpendicular to, the longitudinal axis of the support member; and a rotatable sleeve member rotationally coupled to the holding member for common rotation about the longitudinal axis of the support member; wherein the rotatable sleeve member comprises an annular groove arranged to receive the blocking pin; and wherein two ends of the annular groove define the holding position and the releasing position, respectively, of the holding member. Due to the annular groove, the holding position and the releasing position of the holding member can be accurately defined as two distinct end positions. This contributes to an improved positioning accuracy of the holding member (and of any attachment member held on the holding member). The rotatable sleeve member according to the present disclosure may be constituted by a rotary indexer.

The rotatable sleeve member may comprise an annular rotatable sleeve cam profile. In this case, the holding device may further comprise an axial sleeve member axially movable along the longitudinal axis of the support member, the axial sleeve member comprising an annular axial sleeve cam profile arranged to engage the annular rotatable sleeve cam profile, and an axial groove, parallel with the longitudinal axis of the support member, arranged to receive the blocking pin; and a positioning biasing member configured to bias the axial sleeve member along the longitudinal axis of the support member such that the annular axial sleeve cam profile is pushed against the annular rotatable sleeve cam profile and such that the rotatable sleeve member and the holding member are biased into the holding position or into the releasing position. In this way, the holding member (and a possible attachment member held thereon) can adopt a precise, stable and repeatable holding position and/or releasing position without backlash. These effects are present regardless of the orientation of the holding device in space (for example if the holding device is oriented upside down and the attachment member is held below the holding member).

The support member may extend through the axial sleeve member. The axial sleeve member may be arranged within the rotatable sleeve member. In this case, the axial sleeve member may be referred to as a male sleeve member and the rotatable sleeve member may be referred to as a female sleeve member.

The positioning biasing member may be constituted by an elastic element, such as a compression spring. Alternatively, the positioning biasing member may comprise two repelling magnets. The axial sleeve member and the positioning biasing member may collectively be referred to as a preload mechanism.

According to a further aspect, there is provided an industrial robot comprising an attachment system according to the present disclosure, wherein the industrial robot comprises a robot hand and wherein the attachment system is configured to detachably attach an end effector, such as a gripper finger unit, to the robot hand.

According to a further aspect, there is provided a method for handling the industrial robot according to the present disclosure, the method comprising providing the robot hand with the base member; providing the attachment member within reach of the robot hand; moving the robot hand such that the locking member passes through a releasing structure of the attachment member and engages a stationary engaging structure; moving the robot hand such that the locking member moves from the unlocking position to the locking position by means of the engagement with the engaging structure; and biasing the locking member towards the engageable structure, in order to fix the attachment member to the base member.

The method may further comprise moving the robot hand, with the attachment member fixed to the base member, such that the locking member engages a stationary engaging structure; moving the robot hand such that the locking member moves from the locking position to the unlocking position by means of the engagement with the engaging structure; and moving the robot hand away from the engaging structure such that the locking member passes through the releasing structure of the attachment member.

Although the attachment system and method for handling an industrial robot according to the present disclosure are mainly described in connection with a gripper finger unit comprising the attachment member and a gripper finger, the attachment system and the method may be implemented for detachable attachment of other components or end effectors. Non-limiting examples of alternative applications include attachment systems for detachably attaching a probe or sensor to an industrial robot (not necessarily to a robot hand).

### BRIEF DESCRIPTION OF THE DRAWINGS

Further details, advantages and aspects of the present disclosure will become apparent from the following embodiments taken in conjunction with the drawings, wherein:

FIG. 1: schematically represents a front view of an industrial robot;

FIG. 2: schematically represents a perspective and partially exploded view of a robot hand, a tool, and two attachment systems each comprising a base member and a gripper finger unit;

FIG. 3: schematically represents a perspective view of one of the base members in FIG. 2;

FIG. 4: schematically represents a perspective exploded view of the base member in FIG. 3;

FIG. 5a: schematically represents a bottom view of the base member in FIG. 3;

FIG. 5b: schematically represents a cross sectional view along line A-A in FIG. 5a;

FIG. 6: schematically represents a perspective exploded view of one of the gripper finger units in FIG. 2;

FIG. 7a: schematically represents a top view of an insert element;

FIG. 7b: schematically represents a cross sectional view along line B-B in FIG. 7a;

FIG. 7c: schematically represents a perspective view of the insert element in FIGS. 7a and 7b;

FIG. 8a: schematically represents a partial perspective view of a robot hand comprising two attachment systems where two attachment members adopt an open configuration;

FIG. 8b: schematically represents a partial perspective view of the robot hand in FIG. 8a where the two attachment members adopt a closed configuration;

FIG. 9a: schematically represents a top view of an attachment member;

FIG. 9b: schematically represents a cross sectional view along line C-C in FIG. 9a;

FIG. 10a: schematically represents a perspective exploded view of the tool in FIG. 2;

FIG. 10b: schematically represents an enlarged partial perspective view of the tool in FIG. 10a;

FIG. 11a: schematically represents a perspective view of a finger mounting plate and an attachment system comprising a tool, a base member and a gripper finger unit, during manipulation;

FIG. 11b: schematically represents a top view of the attachment system and the finger mounting plate in FIG. 11a;

FIG. 11c: schematically represents a cross sectional view along line D-D in FIG. 11b;

FIG. 11d: schematically represents a cross sectional view along line E-E in FIG. 11b;

FIG. 12: schematically represents a perspective view of a robot hand and two attachment systems each comprising a base member and a further gripper finger unit;

FIG. 13: schematically represents a partial perspective view of an industrial robot comprising an attachment system with a holding system;

FIG. 14: schematically represents a perspective view of a holding device of the attachment system in FIG. 13;

FIG. 15: schematically represents a perspective exploded view of the holding device in FIG. 14;

FIG. 16: schematically represents a perspective cross sectional view of a rotatable sleeve member;

FIG. 17: schematically represents a perspective view of an axial sleeve member;

FIG. 18a: schematically represents a top view of the holding device in FIG. 14;

FIG. 18b: schematically represents a cross sectional view along line F-F in FIG. 18a;

FIG. 19a: schematically represents a perspective view of a gripper finger unit and a holding device comprising a holding member in a holding position;

FIG. 19b: schematically represents an enlarged view of portion G in FIG. 19a;

FIG. 19c: schematically represents a perspective view of the gripper finger unit and the holding device in FIGS. 19a and 19b during movement of the holding member from the holding position to a release position;

FIG. 19d: schematically represents an enlarged view of portion H in FIG. 19c;

FIG. 19e: schematically represents a perspective view of the gripper finger unit and the holding device in FIGS. 19a to 19d and the holding member in the release position;

FIG. 19f: schematically represents an enlarged view of portion I in FIG. 19e; and

FIG. 20: schematically represents a perspective view of an industrial robot comprising a plurality of holding systems.

### DETAILED DESCRIPTION

In the following, an attachment system comprising a base member and an attachment member for detachable attachment to the base member, an industrial robot comprising the attachment system, and a method for handling the industrial robot, will be described. The same reference numerals will be used to denote the same or similar structural features.

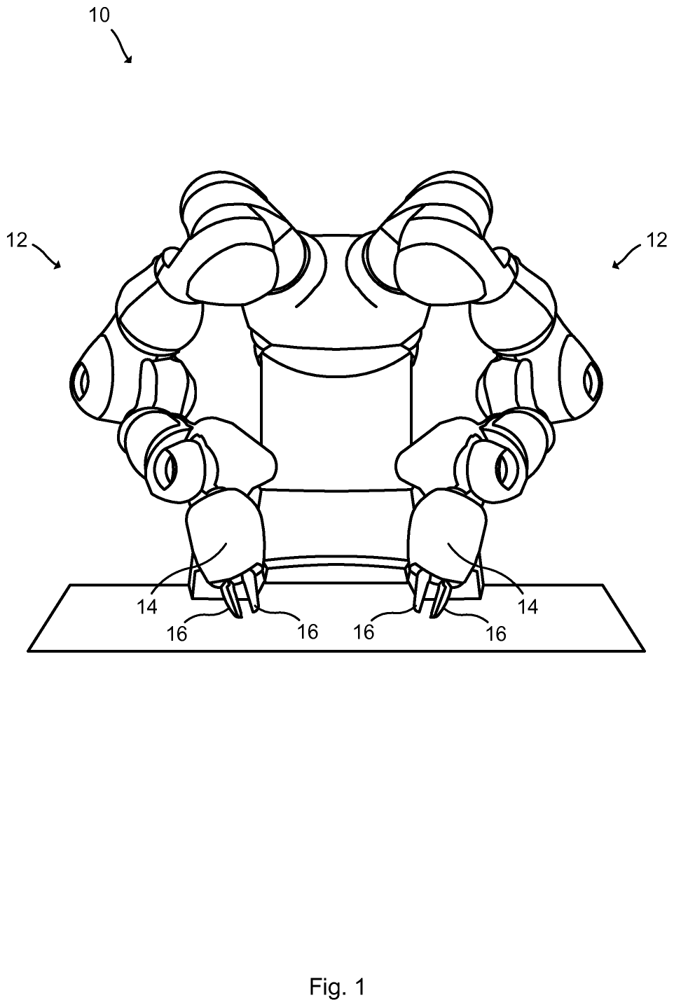

FIG. 1 schematically represents a front view of an industrial robot 10. The industrial robot 10 of this example is constituted by a dual arm robot comprising two robot manipulators 12 with similar or identic configuration. Each robot manipulator 12 comprises a plurality of joints and is thereby movable about a plurality of axes. In the example of FIG. 1, each robot manipulator 12 comprises seven joints and has seven degrees of freedom. Each robot manipulator 12 comprises a robot hand 14. A gripping mechanism comprising two gripper fingers 16 is provided at each robot hand 14. The industrial robot 10 in FIG. 1 is a collaborative robot but industrial robots according to the present disclosure are however not limited to dual arm robots or to collaborative robots.

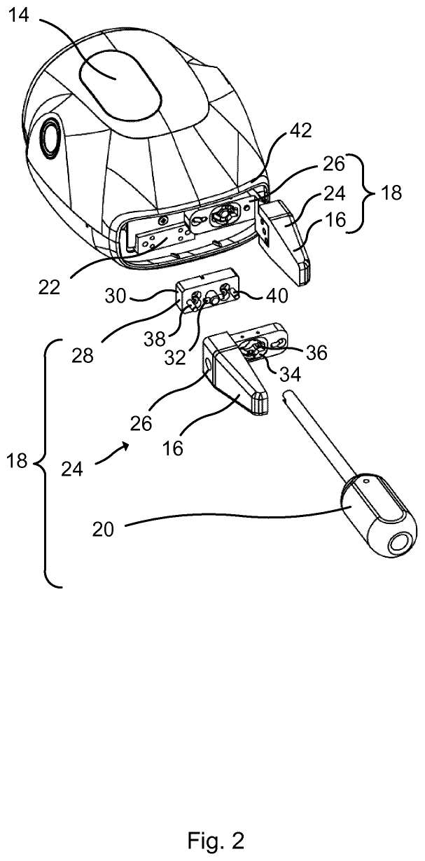

FIG. 2 schematically represents a perspective and partially exploded view of one of the robot hands 14 in FIG. 1. FIG. 2 further shows two attachment systems 18 according to the present disclosure and a tool 20. The robot hand 14 comprises two finger mounting plates 22 (only one is visible in FIG. 2). FIG. 2 further shows two end effectors, here exemplified as gripper finger units 24, each comprising an attachment member 26 and a gripper finger 16 detachably attached to the attachment member 26.

Each attachment system 18 comprises a base member 28 and the attachment member 26. The attachment system 18 may also comprise the gripper finger 16 of the gripper finger unit 24. In FIG. 2, the left base member 28 is detached from the finger mounting plate 22 and the left attachment member 26 is detached from the left base member 28. In FIG. 2, the right base member is attached to the right finger mounting plate (not shown) and the right attachment member 26 is attached to the right base member.

With reference to the separated left base member 28 in FIG. 2, the base member 28 comprises a base 30, here implemented as a plate. In this example, the base member 28 further comprises a locking member 32 movable relative to the base 30 between a locking position and an unlocking position. In FIG. 2, the locking member 32 is in the unlocking position where it is oriented along a longitudinal axis of the base 30.

With reference to the separated left attachment member 26 in FIG. 2, the attachment member 26 comprises an engageable structure 34 and a releasing structure 36. The releasing structure 36 is here implemented as an oblong through hole. When the locking member 32 adopts the illustrated unlocking position, the attachment member 26 can be brought into an attachment position such that the locking member 32 passes through the releasing structure 36 of the attachment member 26. When the attachment member 26 adopts the attachment position relative to the base member 28, the locking member 32 may be moved from the unlocking position to a locking position in order to fix the attachment member 26 to the base member 28. The movement of the locking member 32 may for example be accomplished by rotating the locking member 32 by means of the tool 20. Alternatively, the locking member 32 may be moved by rotating the robot hand 14. The present disclosure is however not limited to a rotational movement of the locking member 32 between the unlocking position and the locking position or to a movement of the locking member 32 by means of the tool 20. One or both of the base 30 and the attachment member 26 may for example be made of steel, aluminum (e.g. heat treated aluminum) or plastic such as POM (polyoxymethylene).

FIG. 2 further shows that the base member 28 comprises two positioning pins, namely a first positioning pin 38 and a second positioning pin 40. The positioning pins 38, 40 are used to unambiguously define a rotational relationship between the attachment member 26 and the base member 28 by engaging with two openings (not denoted) in the attachment member 26. The positioning pins 38, 40 and the openings in the attachment member 26 constitute one example of a positioning arrangement according to the present disclosure. Each base member 28 is designed for permanent installation on the robot hand 14, in this example by fastening the base member 28 to an associated finger mounting plate 22 by means of one or more screws. The robot hand 14 of this example further comprises a hand shell 42 protruding beyond the finger mounting plate 22.

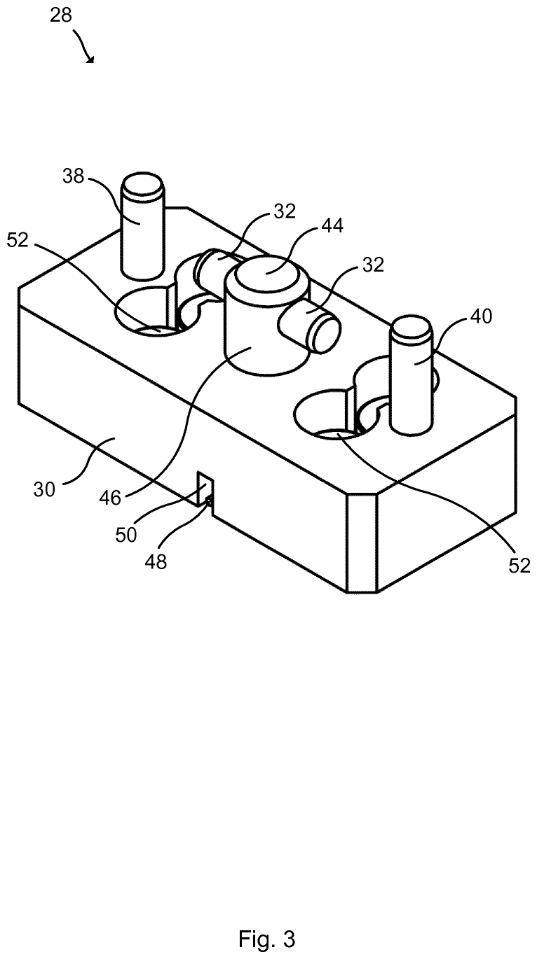

FIG. 3 schematically represents a perspective view of one of the base members 28 in FIG. 2. The base member 28 comprises a locking device 44. The locking device 44 in turn comprises a central element 46 and the locking member 32, here implemented as a transverse locking pin extending through the central element 46. In the illustrated assembled state of the base member 28, the locking member 32 is positioned above the base 30. The purpose of the locking member 32 is to engage the engageable structure 34 of the attachment member 26. The positioning pins 38, 40 are fixed to the base 30, for example by means of adhesive and/or press fitting.

In FIG. 3, a torsion spring arm 48 accommodated in an arm opening 50 of the base 30 can further be seen. FIG. 3 also shows four mounting screws 52 (only two are denoted) for fastening the base member 28 to the finger mounting plate 22.

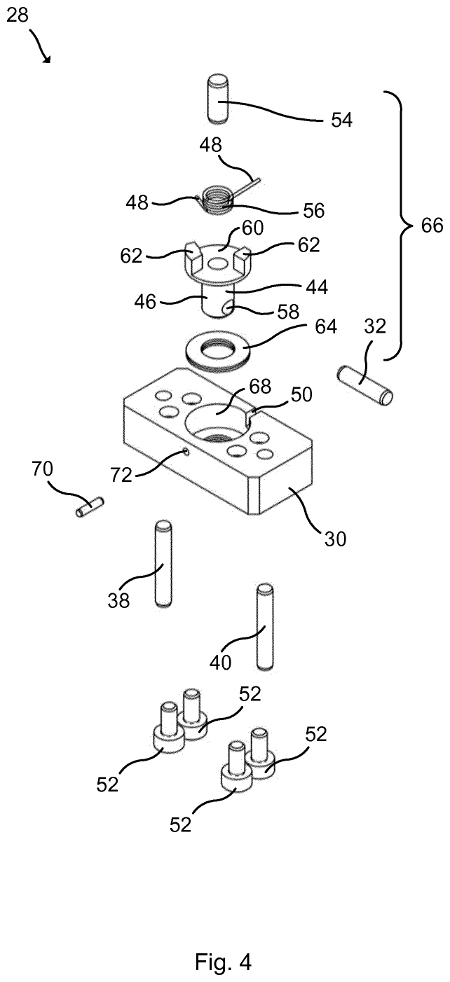

FIG. 4 schematically represents a perspective exploded view of the base member 28 in FIGS. 2 and 3. As illustrated in FIG. 4, the base member 28 of this example comprises a location post 54 and a rotation biasing member 56. The locking device 44 comprises a through hole 58 in the central element 46 for receiving the locking member 32. The locking device 44 further comprises a plate portion 60 having two mechanical stops 62. The design of the locking device 44 in this example resembles a turret.

The rotation biasing member 56 functions to bias the locking member 32 into the unlocking position by generating a torque on the locking device 44. Thereby, it can be ensured that the locking member 32 remains in the unlocking position when the attachment member 26 is removed from the base member 28.

The rotation biasing member 56 is here constituted by an elastic element in the form of a torsion spring having two torsion spring arms 48 (of which one is visible in FIG. 3). However, alternative rotation biasing members for rotationally biasing the locking member 32 towards the unlocking position are conceivable.

FIG. 4 further shows one example of an engaging biasing member 64 of the base member 28. The engaging biasing member 64 is here constituted by an elastic element in the form of a stack of spring washers. The engaging biasing member 64 is configured to exert a pulling force on the locking member 32 towards the engageable structure 34 of the attachment member 26.

The location post 54, the rotation biasing member 56, the locking device 44, the locking member 32 and the engaging biasing member 64 form a release mechanism 66. A cavity 68 is formed in the base 30 for receiving the release mechanism 66. In the example of FIG. 4, the cavity 68 is cylindrical and centrally disposed in the base 30. The release mechanism 66 of this type is constituted by a bayonet mechanism.

The base member 28 further comprises a stop pin 70 for being positioned in a stop pin opening 72 extending into the cavity 68. The stop pin 70 limits rotation of the locking device 44 by engagement with one of the mechanical stops 62. In this example, the two mechanical stops 62 and the stop pin 70 define both the locking position and the unlocking position of the locking member 32.

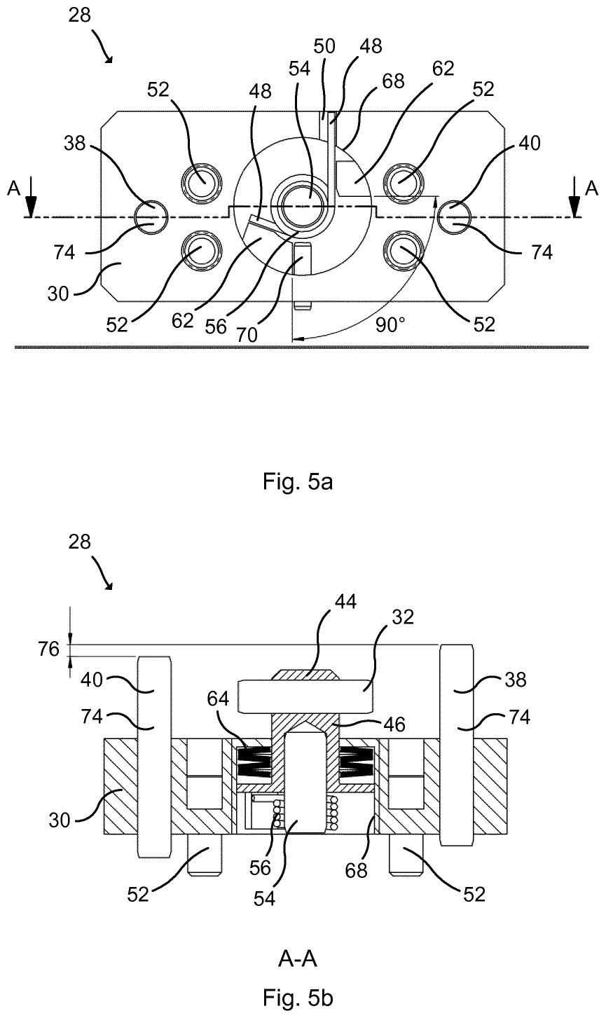

FIG. 5a schematically represents a bottom view of the base member 28 in FIGS. 2 to 4. From FIG. 5a, it can be gathered that the angular range of the movement of the locking member 32 between the unlocking position and the locking position, which is defined by the two mechanical stops 62 and the stop in 70, is 90°.

The positioning pins 38, 40 form a positioning arrangement 74 together with two openings in the attachment member 26. The positioning pins 38, 40 are offset with respect to a longitudinal axis (left/right direction in FIG. 5a) of the base member 28. The positioning arrangement 74 thus has an asymmetric design on the base member 28, e.g. as seen in the plane view of the base member 28 in FIG. 5a.

FIG. 5b schematically represents a cross sectional view along line A-A in FIG. 5a. As can be seen in FIG. 5b, the positioning pins 38, 40 extend through the entire base 30. The downwardly protruding sections of the positioning pins 38, 40 are used to position the base member 28 relative to the finger mounting plate 22. Since the positioning pins 38, 40 extend through the entire base member 28, the same positioning pins 38, 40 can be used both to position the base member 28 relative to the finger mounting plate 22 and to position the attachment member 26 relative to the base member 28. A retrofit of the attachment system 18 to a finger mounting plate 22 of a prior art robot hand can therefore be accomplished while maintaining the positional accuracy of a gripper finger unit 24.

In this example, the rotation biasing member 56 is connected to the location post 54. However, the rotation biasing member 56 may alternatively be connected to, for example, the central element 46 of the locking device 44. In this case, the location post 54 may be omitted.

FIG. 5b further shows that the protruding distance from the base 30 differs between the first positioning pin 38 and the second positioning pin 40. The difference in height between the positioning pins 38, 40 is denoted 76. The first positioning pin 38 thus extends further away from the base 30 than the second positioning pin 40. Thereby, when docking the attachment member 26, or the gripper finger unit 24 comprising the attachment member 26, the first positioning pin 38 can first be engaged with a first opening in the attachment member 26 to secure a positional relation between the attachment member 26 and the base member 28. When the first positioning pin 38 is received in the first opening in the attachment member 26, the attachment member 26 can be rotated until the second positioning pin 40 is aligned with a second opening in the attachment member 26.

The attachment member 26 may then be pushed further towards the base member 28 such that both the first positioning pin 38 is received in the first opening of the attachment member 26 and the second positioning pin 40 is received in the second opening of the attachment member 26. Thereby, a rotational relationship between the base member 28 and the attachment member 26 is secured.

The attachment member 26 may then be pushed further until the attachment member 26 contacts the base 30 in an attachment position. In the attachment position, the locking member 32 may be moved from the unlocking position to the locking position in order to fix the attachment member 26 to the base member 28 by means of the force exerted by the engaging biasing member 64 on the engageable structure 34 of the attachment member 26.

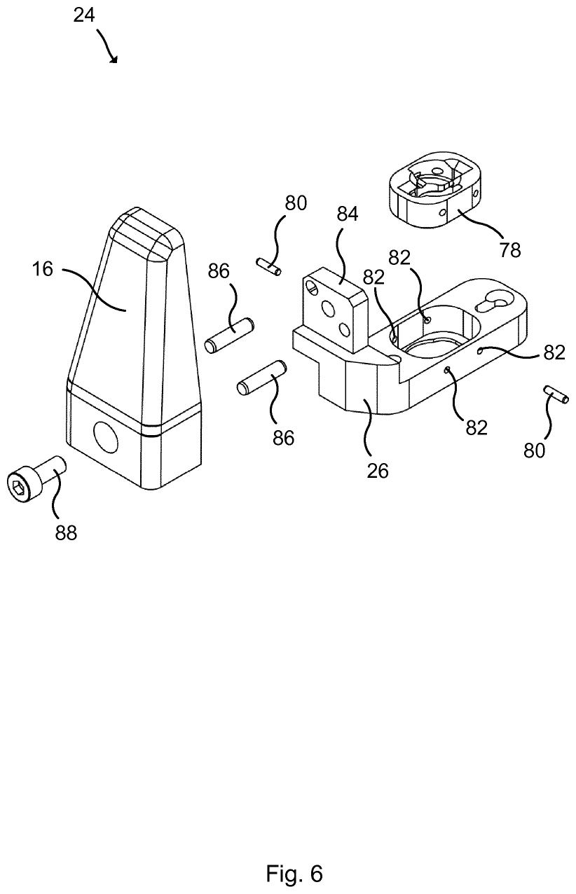

FIG. 6 schematically represents a perspective exploded view of one of the gripper finger units 24 in FIG. 2. The gripper finger unit 24 of this example comprises the attachment member 26, the gripper finger 16 and an insert element 78 comprising the engageable structure 34. The attachment member 26 constitutes a generic, reusable component. In addition to being attachable to the base member 28, the attachment member 26 thus also serves to support the application-specific gripper finger 16.

In the example of FIG. 6, the insert element 78 is detachably attached to the attachment member 26. The insert element 78 may be secured to the attachment member 26 by means of fixation pins 8o extending through fixation pin holes 82 in the attachment member 26 and into the insert element 78. The fixation pins 80 can be pushed all the way out should it be necessary to replace the insert element 78.

The attachment member 26 and the engageable structure 34 may however alternatively be integrally formed. Thus, the attachment member 26 does not necessarily need to comprise the insert element 78.

The attachment member 26 comprises a mounting portion 84 for attachment of the gripper finger 16. The gripper finger 16 comprises an opening (not visible) for receiving the mounting portion 84. Finger positioning pins 86 may be used to locate the gripper finger 16 relative to the mounting portion 84 and a screw 88 may be used to secure the gripper finger 16 to the mounting portion 84.

As can be seen in FIG. 6, the mounting portion 84, which is here exemplified as a protruding tab, is positioned on one side of the attachment member 26 along the longitudinal axis of the attachment member 26. The mounting portion 84 is also offset in a lateral direction (perpendicular to the longitudinal axis) of the attachment member 26 in order to produce collinear movement of two gripper fingers 16.

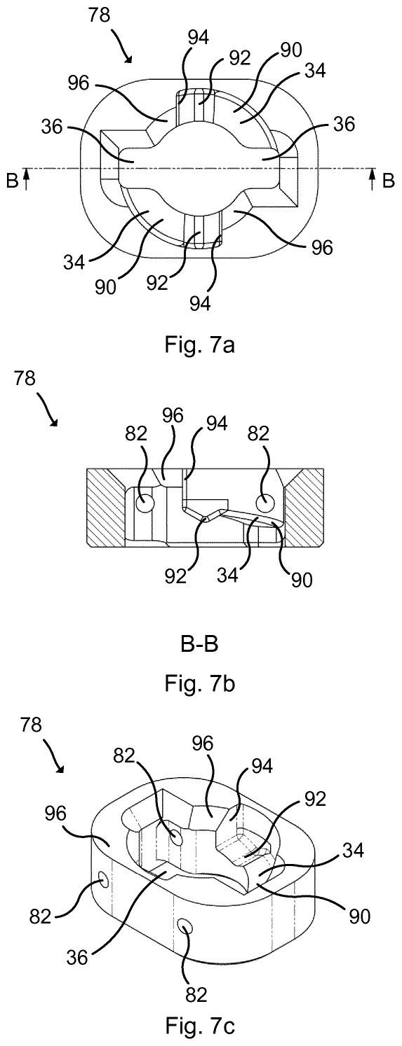

FIG. 7a schematically represents a top view of the insert element 78 in FIG. 6, FIG. 7b schematically represents a cross sectional view along line B-B in FIG. 7a, and FIG. 7c schematically represents a perspective view of the insert element 78 in FIGS. 7a and 7b. With collective reference to FIGS. 7a to 7c, the insert element 78 comprises the engageable structure 34 and the releasing structure 36. The releasing structure 36 is constituted by an opening through the insert element 78 (and through the attachment member 26) such that the locking member 32 can pass therethrough when adopting the unlocking position. The releasing structure 36 is aligned with the longitudinal direction of the attachment member 26.

The engageable structure 34 of this example is constituted by two cam profiles 90. Each cam profile 90 is constituted by a helical surface or ramp.

The insert element 78 may thus be referred to as a helical insert. The engaging biasing member 64 produces a controlled pulling force on the locking member 32 as the locking member 32 travels along the engageable structure 34.

The engageable structure 34 comprises a detent or seat 92 at the end of each cam profile 90. When the locking member 32 adopts the locking position, the locking member 32 is pulled into the seats 92 by the engaging biasing member 64 in order to stably maintain the locking member 32 in the locking position.

The insert element 78 further comprises a mechanical stop 94 beyond each seat 92. The mechanical stops 94 prevent further rotation of the locking member 32 beyond the locking position. The insert element 78 further comprises a chamfer 96 for facilitating access to the locking member 32 with the tool 20.

The insert element 78 may be made of a low friction material. The insert element 78 may for example be 3D printed in a nylon based material to reduce friction. One example of a suitable nylon base material is FDM® carbon-filled nylon. The insert element 78 may alternatively be made of metal. In this case, the insert element 78 may optionally be lubricated to further reduce friction.

When the locking member 32 engages the engageable structure 34 during movement to the locking position, the locking member 32 travels up the engageable structure 34. Due to this movement, the engaging biasing member 64 is compressed. When the locking member 32 reaches the locking position, the engaging biasing member 64 generates the necessary preload and presses the attachment member 26 firmly against the base member 28.

In this way, backlash in the connection between the attachment member 26 and the base member 28 is eliminated. The preload may for example be 50 N to 100 N.

In this example, the locking member 32 adopts the unlocking position when being aligned with the releasing structure 36 (i.e. parallel with the longitudinal axis of the attachment member 26 and the insert element 78) and adopts the locking position when being rotated 90° and seated in the seats 92 (i.e. parallel with the lateral axis of the attachment member 26 and the insert element 78). However, the present disclosure is not limited to a rotational movement between the locking member 32 and the base 30 or to a rotational movement of 90° between the locking member 32 and the base 30.

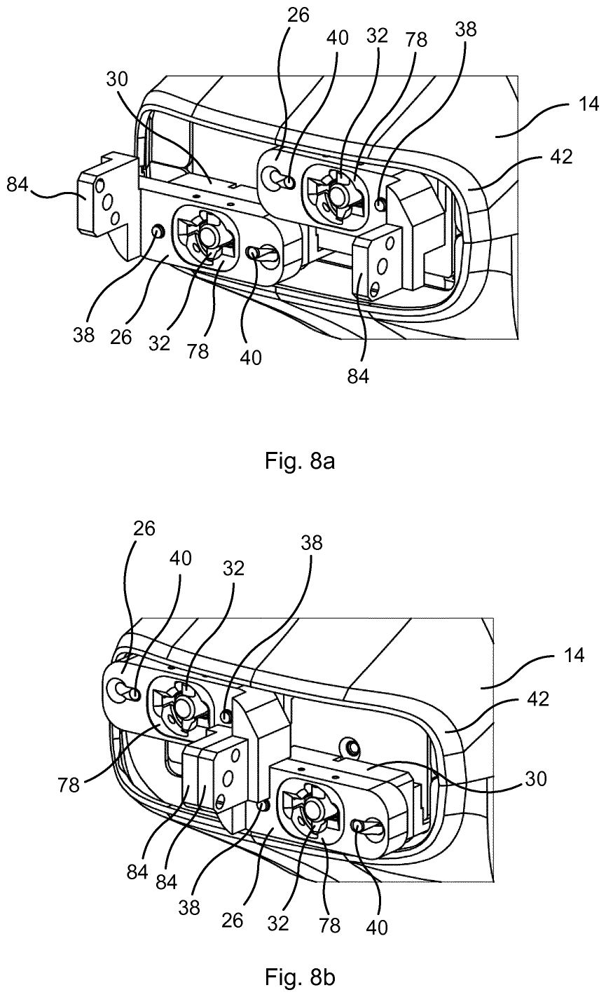

FIG. 8a schematically represents a partial perspective view of a robot hand 14 comprising two attachment systems 18 where two attachment members 26 adopt an open configuration, and FIG. 8b schematically represents a partial perspective view of the robot hand 14 in FIG. 8a where the two attachment members 26 adopt a closed configuration. With collective reference to FIGS. 8a and 8b, each mounting portion 84 is offset towards a center line (parallel with an opening/closing direction) such that collinear movements of the mounting portions 84 are achieved.

Furthermore, each mounting portion 84 also protrudes beyond the hand shell 42. This removes the constraints imposed by the need to avoid collision with the hand shell 42 and allows simple geometrically-mirrored gripper fingers 16 to be used in applications requiring offset or angled grips. Furthermore, the amount of 3D printed material required to make a gripper finger 16 is significantly reduced since the attachment member 26 need no longer be incorporated in the design.

Due to the asymmetric placement of the positioning pins 38, 40 on the base 30, attachment of the attachment members 26 to the base members 28 with incorrect polarity can be prevented. The positioning of the mounting portion 84 on the attachment member 26 removes the open/closed state ambiguity present in prior art robot hands and provides a grasp force symmetry. That is, the mounting portions 84 can move between the open configuration in FIG. 8a and the closed configuration in FIG. 8b along one single straight line.

As can be gathered from FIGS. 8a and 8b, the provision of the mounting portions 84 as protruding tabs on one side (along the longitudinal axis of the attachment member 26) of each attachment member 26 gives an unambiguous visual indication of the open configuration (FIG. 8a) and the closed configuration (FIG. 8b) of the gripping mechanism of the robot hand 14.

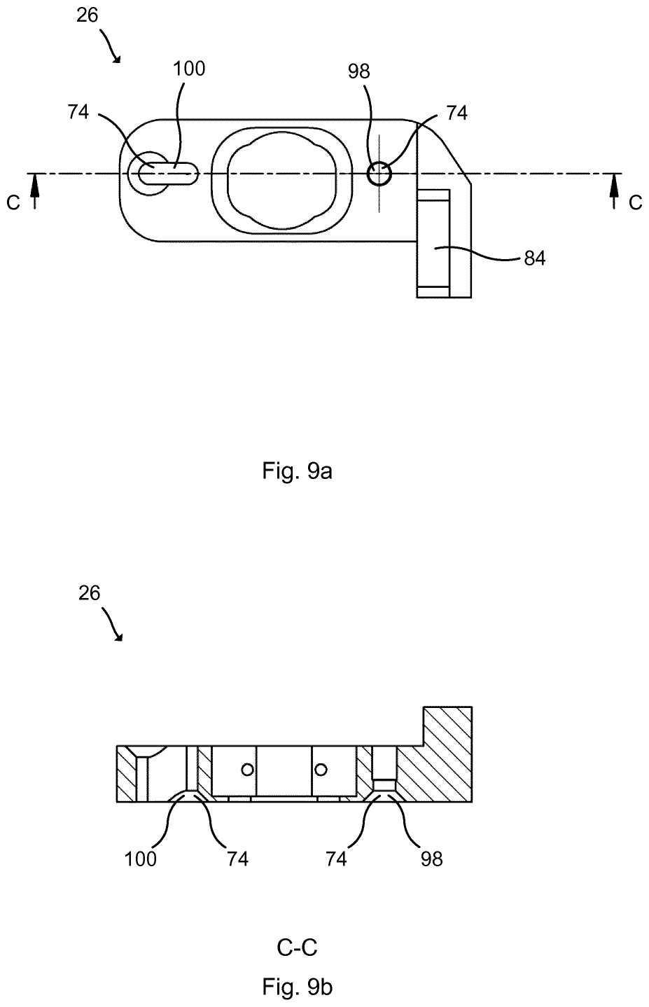

FIG. 9a schematically represents a top view of an attachment member 26 (without the insert element 78) and FIG. 9b schematically represents a cross sectional view along line C-C in FIG. 9a. With collective reference to FIGS. 9a and 9b, the two openings of the positioning arrangement 74 can be seen. A first positioning opening 98 is constituted by a circular through hole in the attachment member 26 and a second positioning opening 100 is constituted by a through slot in the attachment member 26 having an elongation direction parallel with a longitudinal axis of the attachment member 26. Both the first positioning opening 98 and the second positioning opening 100 are chamfered. The first positioning opening 98 of the attachment member 26 is configured to receive the first positioning pin 38 of the base member 28 and the second positioning opening 100 of the attachment member 26 is configured to receive the second positioning pin 40 of the base member 28.

The first positioning opening 98 and the second positioning opening 100 of the attachment member 26 and the first positioning pin 38 and the second positioning pin 40 of the base member 28 together form one example of a positioning arrangement 74 according to the present disclosure for unambiguously defining a rotational relationship between the base member 28 and the attachment member 26 in the attachment position of the attachment member 26. Alternative designs of the positioning arrangement 74 are conceivable.

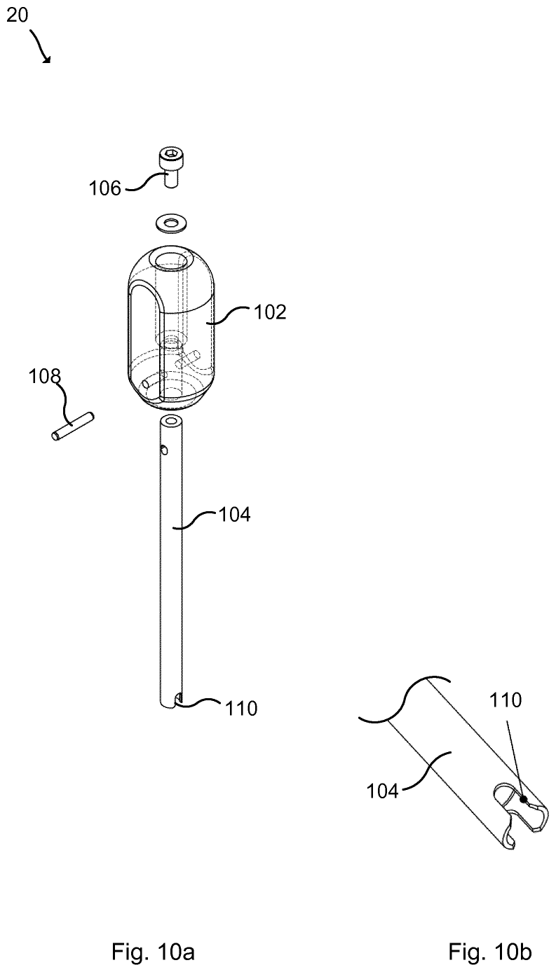

FIG. 10a schematically represents a perspective exploded view of the tool 20 in FIG. 2, and FIG. 10b schematically represents an enlarged partial perspective view of the tool 20 in FIG. 10a. With collective reference to FIGS. 10a and 10b, the tool 20 comprises a handle 102 and a shaft 104. In this example, the handle 102 is fastened to the shaft 104 by means of a fixation screw 106 and the handle 102 is prevented from rotating relative to the shaft 104 by means of an antirotation pin 108 extending through the handle 102 and the shaft 104. The end of the shaft 104 is tubular and has an inner diameter larger than the outer diameter of the central element 46. The end of the shaft 104 comprises a slot 110. Thus, by inserting the shaft 104 over the central element 46, the locking member 32 can be received in the slot 110 for a stable rotation of the locking member 32 between the locking position and the unlocking position. The tool 20 enables a manual quick change of an attachment member 26, or of an end effector 24 comprising the attachment member 26.

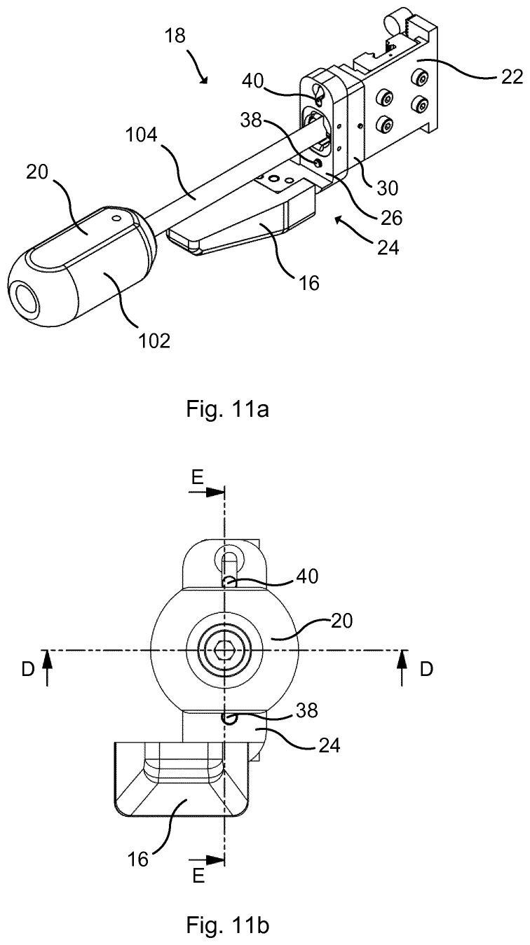

FIG. 11a schematically represents a perspective view of an attachment system 18 comprising a tool 20, a base member 28 (only the base 30 is visible) and a gripper finger unit 24, and a finger mounting plate 22 during manipulation, FIG. 11b schematically represents a top view of the attachment system 18 and the finger mounting plate 22 in FIG. 11a, FIG. 11c schematically represents a cross sectional view along line D-D in FIG. 11b, and FIG. 11d schematically represents a cross sectional view along line E-E in FIG. 11b. With collective reference to FIGS. 11a to 11d, methods for handling the attachment member 26 in relation to the base member 28 will be described.

In order to install a gripper finger unit 24 to the robot hand 14, the attachment member 26 may first be rotationally locked relative to the base member 28 by means of the positioning arrangement 74 (e.g. by receiving the two positioning pins 38, 40 of the base member 28 in the two positioning openings 98, 100 of the attachment member 26). The positioning arrangement 74 prevents the gripper finger unit 24 from being positioned with an incorrect polarity. During this step, the locking member 32 is unaffected and thereby adopts the unlocking position by means of the rotation biasing member 56. The gripper finger unit 24 may then be pushed towards the base member 28 such that the locking member 32 passes through the releasing structure 36 of the attachment member 26 and until the attachment member 26 adopts the attachment position relative to the base member 28.

The locking member 32 may then be moved from the unlocking position to the locking position while engaging the engageable structure 34 and compressing the engaging biasing member 64. This may be carried out by rotating the locking member 32 from the unlocking position to the locking position by means of the tool 20. The attachment member 26 is held firmly against the base member 28 and by means of the preload generated by the engaging biasing member 64 and ensures that the gripper finger unit 24 remains fixed relative to the base member 28 while gripping.

In order to detach the gripper finger unit 24 from the robot hand 14, the locking member 32 is moved from the locking position to the unlocking position, e.g. by rotating the locking member 32 by means of the tool 20. The attachment member 26 then remains in the attached position but is no longer fixed to the base member 28. The locking member 32 stays in the unlocking position due to the torque exerted on the locking member 32 by the rotation biasing member 56. The gripper finger unit 24 may then be removed away from the base member 28 by hand such that the locking member 32 passes through the releasing structure 36 of the attachment member 26.

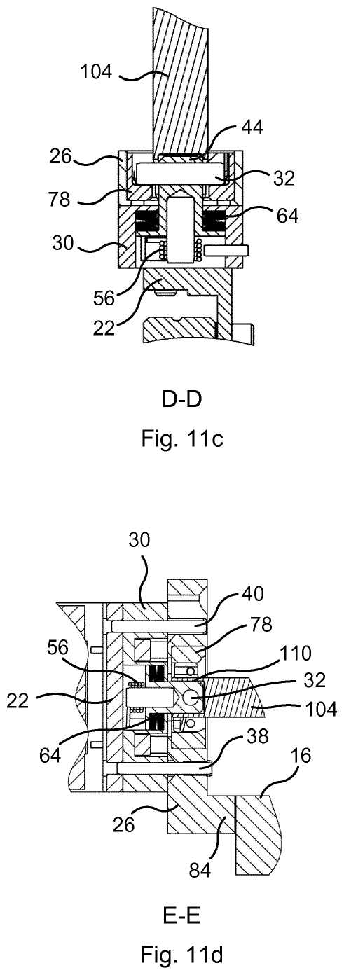

FIG. 12 schematically represents a perspective view of a robot hand 14 and two attachment systems 18 each comprising a base member 28 and a further gripper finger unit 24. Mainly differences with respect to FIGS. 2 to 11 will be described.

In FIG. 12, each gripper finger unit 24 comprises an attachment member 26 and a gripper finger 16 integrally formed with the attachment member 26. Instead of the insert element 78, each gripper finger unit 24 further comprises an engageable structure 34 and a releasing structure 36 integrally formed in the attachment member 26. The gripper finger units 24 of this example may for example be produced by means of 3D printing provided that the printing resolution is sufficiently high to produce the engageable structure 34.

The attachment system 18 according to the present disclosure thus allows the attachment member 26 to be replaced by another replacement member (and optionally a gripper finger 16 attached thereto) in seconds by using the tool 20 to turn the locking member 32 from the locking position to the unlocking position, lifting away the attachment member 26, attaching a new attachment member 26 (and optionally a gripper finger 16 attached thereto) and turning the locking member 32 from the unlocking position to the locking position to fix the new attachment member 26 to the base member 28.

Furthermore, the provision of the locking member 32 connected to the base 30 and the provision of the positioning pins 38, 40 fixedly connected to the base 30 eliminates the risk of screws becoming lost or damaged and eliminates the possibility of omitting screws or positioning pins when replacing a gripper finger unit 24. The positioning arrangement 74 according to the present disclosure also improves positional accuracy of a gripper finger unit 24 and prevents gripper finger units 24 from being connected to the base member 28 with incorrect polarity.

Furthermore, the attachment member 26 can be firmly held against the base member 28 only by the force generated by the engaging biasing member 64. The risk of overtightening of screws is therefore eliminated. The locking member 32 constitutes a “binary” locking mechanism that is only movable between the locking position and the unlocking position. Therefore, the skill requirements of an operator are reduced. The operator does for example not have to fasten a screw with a particular torque in order to correctly fix a gripper finger unit 24 to the robot hand 14.

Furthermore, a base member 28 can be fastened to an existing finger mounting plate 22 of a robot hand 14. The attachment system 18 according to the present disclosure can therefore be retrofitted to an existing industrial robot 10.

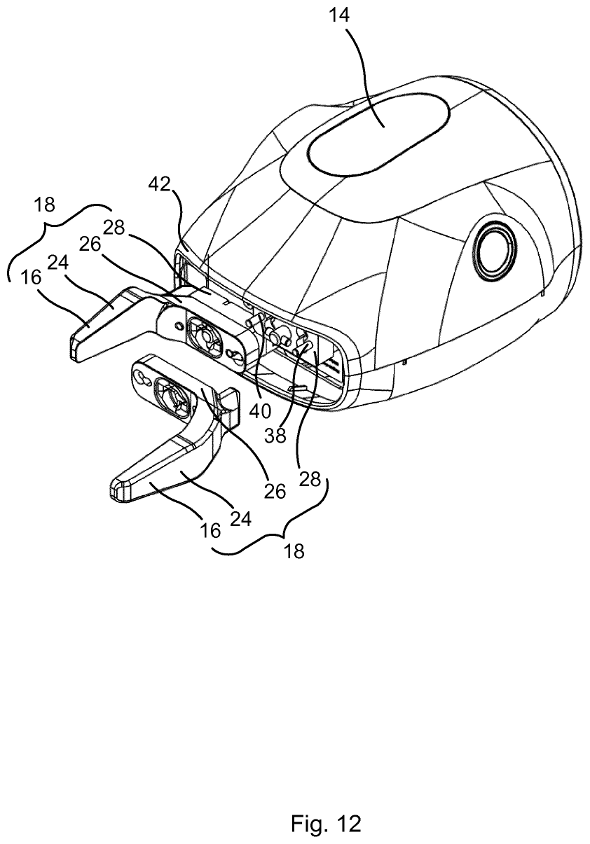

FIG. 13 schematically represents a partial perspective view of an industrial robot 10 comprising an attachment system 18 with one example of a holding system 112 according to the present disclosure. The holding system 112 comprises a plurality of holding devices 114, each for releasably holding an attachment member 26, such as an attachment member 26 of a gripper finger unit 24. In this example, each holding device 114 is constituted by a pillar which is connected with one end to a support base 116. Each holding device 114 further comprises a holding member 118 at the respective opposite end.

In FIG. 13, three holding devices 114 each holds a gripper finger unit 24 on the respective holding member 118 and a fourth gripper finger unit 24 is illustrated as separated from a fourth holding device 114. As can be seen on the fourth holding device 114 in FIG. 13, the holding device 114 comprises a locating pin 120 on the holding member 118.

The locating pin 120 is arranged to mate with the oblong second positioning opening 100 of the attachment member 26. This mating can take place even when the first positioning opening 98 of the attachment member 26 receives the first positioning pin 38 of the base member 28 and when the second positioning opening 100 of the attachment member 26 receives the second positioning pin 40 of the base member 28. The positioning opening 100 of the attachment member 26 and the locating pin 120 of the holding member 118 thus constitute one example of a positioning arrangement 74 according to the present disclosure.

In FIG. 13, the gripper finger units 24 are of two different types. However, additional holding devices 114 may be arranged within the workspace of the industrial robot 10 and the gripper finger units 24 may be of additional or other types. The number of holding devices 114 is only limited by the workspace reachability of the industrial robot 10. Again, also end effectors other than gripper finger units 24, or attachment members 26 alone, may be held by the holding devices 114.

The support base 116 of the holding system 112 is in this example constituted by a base plate which may be fixed in the workspace of the industrial robot 10 e.g. to the body of the industrial robot 10. Several such holding systems 112 may be arranged in the workspace of the industrial robot 10.

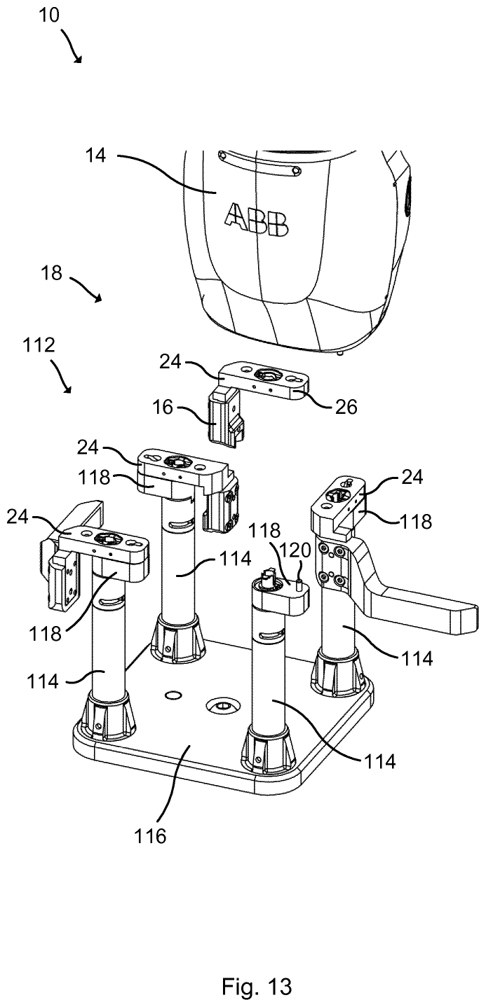

FIG. 14 schematically represents a perspective view of one holding device 114 of the attachment system 18 in FIG. 13. The holding device 114 is configured to releasably hold an attachment member 26 detached from the industrial robot 10.

The holding device 114 comprises a stationary support member 122. The holding device 114 of this example also comprises a tubular cover 124, covering the support member 122, and a socket 126 for securing the support member 122 to the support base 116 (not shown in FIG. 14).

The support member 122 defines a longitudinal axis 128. The support member 122 comprises a tubular portion 130 at one end of the support member 122. Two holding stops 132 are provided on the support member 122 and each holding stop 132 protrudes laterally away from the support member 122, i.e. in directions perpendicular to the longitudinal axis 128 of the support member 122. In FIG. 14, the holding stops 132 are constituted by tabs protruding from the tubular portion 130.

The support member 122 passes through a holding member opening (not denoted) in the holding member 118. The holding member 118 is rotatably arranged on the support member 122 for rotation about the longitudinal axis 128 of the support member 122. The longitudinal axis 128 of the support member 122 may thus alternatively be referred to as a rotational axis of the holding member 118. The holding member 118 is here constituted by a location block.

In FIG. 14, the holding member 118 is positioned in a holding position. The holding member 118 of this example is arranged to rotate 90° about the longitudinal axis 128 of the support member 122 from the holding position into a releasing position. The purpose of the holding stops 132 is to pass through the releasing structure 36 of the attachment member 26 when the holding member 118 adopts the releasing position and to grasp around the attachment member 26 when the holding member 118 adopts the holding position.

The holding device 114 further comprises a holding biasing member (not visible in FIG. 14). The holding biasing member is configured to bias the holding member 118 towards the holding stops 132 to provide a clamping interface between the holding member 118 and the holding stops 132. Thus, an attachment member 26, for example an attachment member 26 of a gripper finger unit 24, can be forcibly held between the holding member 118 and the holding stops 132 in the holding position of the holding member 118 according to FIG. 14 by means of the force exerted by the holding biasing member.

The locating pin 120 is secured to the holding member 118, for example by means of press fitting and/or gluing, and protrudes away from the holding member 118 in a direction parallel with the longitudinal axis 128 of the support member 122. In addition to the positioning opening 100 of the attachment member 26 and the locating pin 120 of the holding member 118, the positioning arrangement 74 according to the present disclosure may also comprise the through opening 36 of the attachment member 26 and the support member 122 (such as the tubular portion 130).

FIG. 14 further shows that the support member 122 comprises two receiving slots 134 arranged in the tubular portion 130. The receiving slots 134 constitute one example of an engaging structure according to the present disclosure. The receiving slots 134 are configured to receive the locking pin 32. The locking pin 32 can be inserted into the receiving slots 134 by moving the locking pin 32 towards the holding device 114 in a direction substantially parallel with the longitudinal axis 128 of the support member 122.

The tubular portion 130 and the receiving slots 134 thus have the same size and function as the shaft 104 and the slots 110 of the tool 20 (see FIGS. 10a and 10b). The tubular portion 130 has an inner diameter substantially corresponding to (e.g. slightly larger than) the outer diameter of the central element 46 of the base member 28 and the receiving slots 134 have a width substantially corresponding to (e.g. slightly larger than) the locking member 32 (see FIG. 3).

FIG. 14 further shows that the holding member 118 of this example has a longitudinal appearance and comprises a longitudinal axis 136. In the holding position of the holding member 118 illustrated in FIG. 14, the longitudinal axis 136 of the holding member 118 is substantially aligned with the two receiving slots 134.

When the holding member 118 is rotated into the releasing position, the longitudinal axis 136 of the holding member 118 is aligned with the two holding stops 132 of the support member 122. When the holding member 118 adopts the releasing position, the locating pin 120 of the holding member 118 can be received in the oblong second positioning opening 100 of the attachment member 26 and the tubular portion 130 of the support member 122 can be received in the through opening 36 of the attachment member 26. In this way, a rotational relationship between the holding member 118 and the attachment member 26 can be unambiguously defined.

The holding device 114 of the example in FIG. 14 further comprises a rotatable sleeve member 138 positioned below the holding member 118. The rotatable sleeve member 138 encloses the support member 122. The rotatable sleeve member 138 comprises an axial rotatable sleeve member slot 140 and the holding member 118 comprises an axially protruding holding member tab 142 engaged in the rotatable sleeve member slot 140. This configuration may be reversed.

The holding member tab 142 is allowed to move axially, parallel with the longitudinal axis 128 of the support member 122, within the rotatable sleeve member slot 140. Due to the engagement of the holding member tab 142 in the rotatable sleeve member slot 140, the holding member 118 is prevented from rotating relative to the rotatable sleeve member slot 140, about the longitudinal axis 128 of the support member 122. The holding member tab 142 and the rotatable sleeve member slot 140 thus constitute a sliding coupling that transfers rotational movements between the holding member 118 and the rotatable sleeve member 138. The rotatable sleeve member 138 is thereby rotationally coupled to the holding member 118 for common rotation about the longitudinal axis 128 of the support member 122. Axial movement of the holding member 118 is however not transferred to the rotatable sleeve member 138.

FIG. 14 further shows that the rotatable sleeve member 138 comprises two annular grooves 144. The holding device 114 comprises a blocking pin 146 fixed to the stationary support member 122. The blocking pin 146 passes through the support member 122 and is received in the two annular grooves 144 of the rotatable sleeve member 138. The end positions of the blocking pin 146 within the annular grooves 144 define the holding position and the releasing position, respectively, of the holding member 118. The two annular grooves 144 thus limit the angular range of rotation of the holding member 118 to 90°. Only one annular groove 144 may alternatively be provided in the rotatable sleeve member 138.

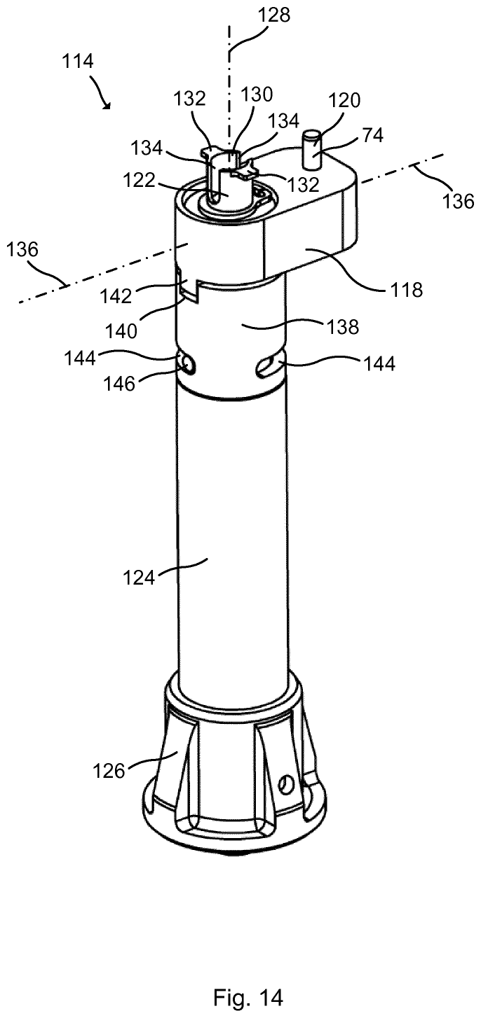

FIG. 15 schematically represents a perspective exploded view of the holding device 114 in FIG. 14. In FIG. 15, the holding biasing member 148 can be seen. The holding biasing member 148 is here constituted by a compression spring. The holding biasing member 148 may alternatively be constituted by, for example, other elastic elements. FIG. 15 shows that the support member 122 also comprises a shaft or elongated rod 150.

FIG. 15 further shows that the holding device 114 additionally comprises an axial sleeve member 152. The axial sleeve member 152 is hollow and is configured to enclose the support member 122. The axial sleeve member 152 comprises two axial grooves 154 (only one if visible in FIG. 15) in which the blocking pin 146 can be received. In this way, the axial sleeve member 152 is allowed to move axially along the support member 122 but is prevented from rotating relative to the support member 122. The axial sleeve member 152 comprises an annular axial sleeve cam profile 156 for mating with a complementary annular rotatable sleeve cam profile (not visible in FIG. 14) of the rotatable sleeve member 138.

The holding device 114 further comprises a positioning biasing member 158. The positioning biasing member 158 is here constituted by a compression spring. The positioning biasing member 158 may alternatively be constituted by, for example, other elastic elements or repelling magnets. The positioning biasing member 158 preloads the axial sleeve member 152 against the rotatable sleeve member 138.

FIG. 15 further shows that the holding device 114 of this example comprises a first washer 16o and an associated first retaining ring 162, a second washer 164 and an associated second retaining ring 166 and a third washer 168 and an associated third retaining ring 170. The support member 122 comprises a first seat 172 in which the first retaining ring 162 can be seated to hold the first washer 16o, a second seat 174 in which the second retaining ring 166 can be seated to hold the second washer 164 and a third seat 176 in which the third retaining ring 170 can be seated to hold the third washer 168.

The first washer 160 provides a stop that prevents the holding member 118 from moving out over the support member 122. The first washer 160 also sets a minimum gap of the clamping interface between the holding member 118 and the holding stops 132. The second washer 164 provides a seat for the positioning biasing member 158. The third washer 168 provides a seat for the support member 122 within the tubular cover 124.

FIG. 15 further shows that the support member 122 comprises a blocking pin hole 178 and a socket fixing pin hole 180. The blocking pin 146 is inserted through the annular grooves 144 of the rotatable sleeve member 138, through the axial grooves 154 of the axial sleeve member 152 and through the blocking pin hole 178 of the support member 122 and thus functions as an axial blocking pin for the rotatable sleeve member 138 and as a rotation blocking pin for the axial sleeve member 152. A socket fixing pin 182 is inserted through the socket 126 and into the socket fixing pin hole 180 of the support member 122.

FIG. 15 further shows a location pin hole 184 in the holding member 118 in which the locating pin 120 can be fastened. FIG. 15 further shows the holding member opening 186 in the holding member 118 through which the support member 122 passes. FIG. 15 further shows a socket screw 188 and a socket washer 190 for fastening the socket 126 to the support base 116.

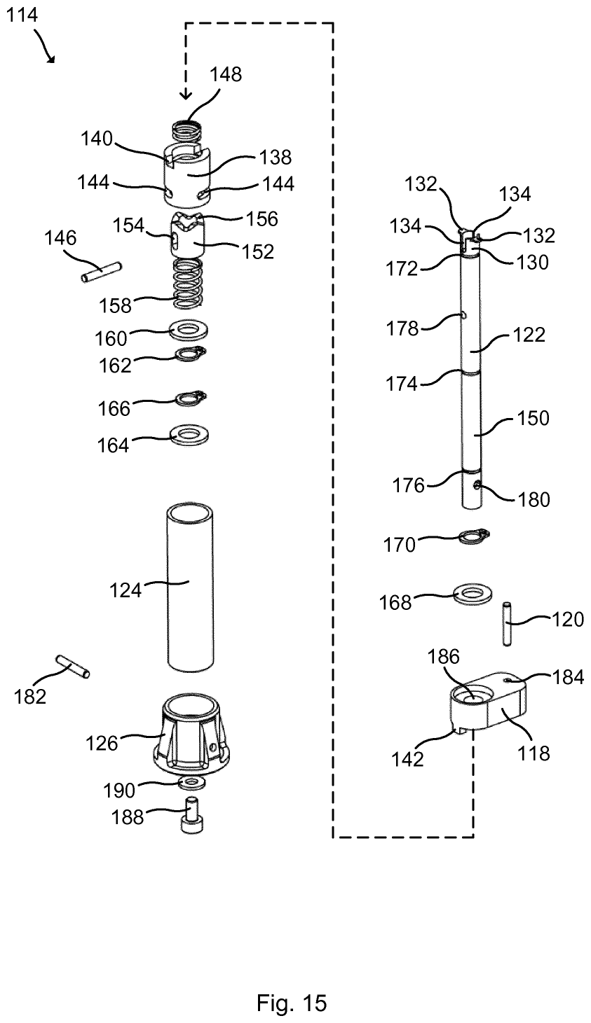

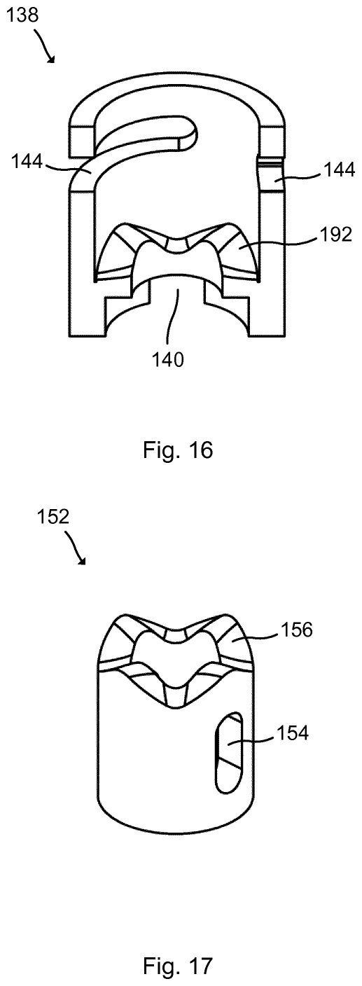

FIG. 16 schematically represents a perspective cross sectional view of the rotatable sleeve member 138. In FIG. 16, the annular rotatable sleeve cam profile 192 and the two annular grooves 144 of the rotatable sleeve member 138 can be seen. Note that the rotatable sleeve member 138 is oriented upside down in comparison with FIG. 15. FIG. 17 schematically represents a perspective view of the axial sleeve member 152.

With collective reference to FIGS. 16 and 17, each of the annular axial sleeve cam profile 156 of the axial sleeve member 152 and the annular rotatable sleeve cam profile 192 of the rotatable sleeve member 138 comprises four peaks and four valleys (not denoted) annularly evenly distributed and complementary to each other. Thus, when the axial sleeve member 152 and the rotatable sleeve member 138 adopt a relative rotational orientation where peaks are aligned with peaks and valleys are aligned with valleys, the axial sleeve member 152 and the rotatable sleeve member 138 are axially displaced. When the axial sleeve member 152 and the rotatable sleeve member 138 adopt a relative rotational orientation where the peaks of the annular axial sleeve cam profile 156 are aligned with the valleys of the annular rotatable sleeve cam profile 192 and the valleys of the annular axial sleeve cam profile 156 are aligned with the peaks of the annular rotatable sleeve cam profile 192, the axial sleeve member 152 can be brought closer to the rotatable sleeve member 138 along the longitudinal axis 128 of the support member 122. The latter state may be referred to as a mating relationship.

The positioning biasing member 158 preloads the axial sleeve member 152 against the rotatable sleeve member 138. Due to this preload, the rotatable sleeve member 138 is forced to rotate into the mating relationship with the axial sleeve member 152. The complementarity of the annular axial sleeve cam profile 156 and the annular rotatable sleeve cam profile 192 together with the positioning biasing member 158 thereby cause a tendency for the rotatable sleeve member 138, and consequently also for the holding member 118, to settle in either the holding position or in the releasing position.

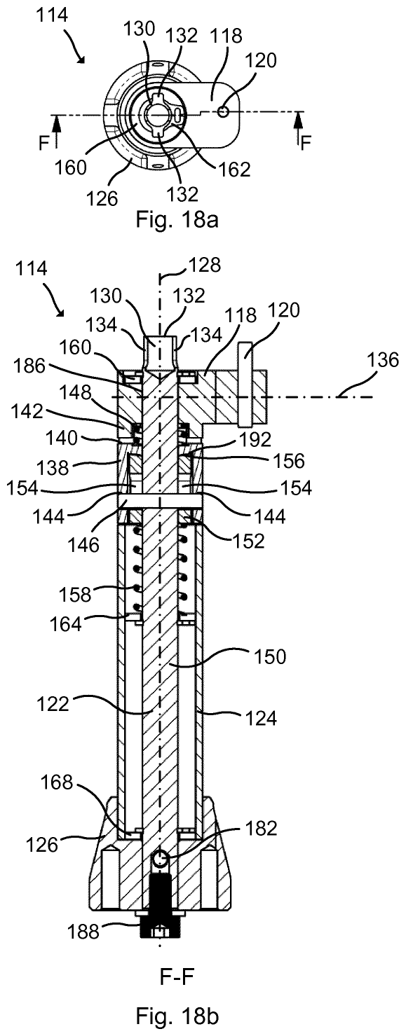

FIG. 18a schematically represents a top view of the holding device 114 in FIG. 14, and FIG. 18b schematically represents a cross sectional view along line F-F in FIG. 18a. Also in FIGS. 18a and 18b, the holding member 118 is in the holding position. FIG. 18b shows that the holding biasing member 148 is seated on the rotatable sleeve member 138 to preload the holding member 118 towards an attachment member 26 such that the attachment member 26 can be pushed against the holding stops 132.

As can be seen in FIG. 18b (and also in FIG. 14), there is a small axial gap between the holding member tab 142 and the rotatable sleeve member slot 140. The holding member 118 can thereby be pushed slightly axially downwards (i.e. away from the holding stops 132) against the force of the holding biasing member 148.

With main reference to FIGS. 13 to 18b, a method for detaching a gripper finger unit 24 from a robot hand 14 and for attaching the gripper finger unit 24 to the holding device 114 will now be described. The holding member 118 is initially positioned in the releasing position. This position is defined by the blocking pin 146 and the annular groove 144. The holding member 118 is also stably held in the releasing position due to the annular rotatable sleeve cam profile 192, the annular axial sleeve cam profile 156 and the positioning biasing member 158.

The robot hand 14 is then moved to an engaging position where the attachment member 26 of the gripper finger unit 24 mates with the holding member 118 of the holding device 114, where the holding stops 132 of the holding device 114 pass through the releasing structure 36, where the locking pin 32 is received in the receiving slots 134, and where the locating pin 120 of the holding member 118 is received in the second positioning opening 100 of the attachment member 26. The robot hand 14 may then optionally push the holding member 118 slightly downwards against the compression of the holding biasing member 148 such that the attachment member 26 can be accommodated under the holding stops 132 after the following rotation.

The robot hand 14 is then rotated 90° around the longitudinal axis 128 of the support member 122. This rotation causes the holding member 118 to rotate from the releasing position to the holding position. The same rotation also causes the locking pin 32 to rotate from the locking position to the unlocking position due to the engagement with the receiving slots 134. The same rotation also causes the two holding stops 132 to grasp the attachment member 26.

In order to rotate the robot hand 14, a temporary tool may be specified in the control system of the industrial robot 10, which temporary tool has an axis of rotation centered on a rotational axis of the locking pin 32 of the base member 28. The same axis of rotation is concentric with, or substantially concentric with, the longitudinal axis 128 of the support member 122.

As the holding member 118 is rotated, the holding member tab 142 engages the rotatable sleeve member slot 140 such that the holding member 118 and the rotatable sleeve member 138 rotate together. When the rotatable sleeve member 138 rotates, the complementary fit between the annular rotatable sleeve cam profile 192 and the annular axial sleeve cam profile 156 is altered and the axial sleeve member 152 is consequently axially displaced away from (downwards in FIG. 18b) the rotatable sleeve member 138 against the force of the positioning biasing member 158. The axial sleeve member 152 is prevented from rotating due to the engagement of the blocking pin 146 in the axial groove 154 and the rotatable sleeve member 138 is prevented from moving axially due to the engagement of the blocking pin 146 in the annular grooves 144. When the rotation of the holding member 118 is at 45°, the force generated by the positioning biasing member 158 is the highest. When the rotation of the holding member 118 passes 45°, the holding member 118 shifts from being biased into the releasing position to being biased into the holding position. Once the robot hand 14 and the attachment member 26 have rotated 90° into the holding position, the annular axial sleeve cam profile 156 and the annular rotatable sleeve cam profile 192 thus ensure that the holding member 118 remains in the holding position.

When the holding member 118, with the attachment member 26 of the gripper finger unit 24 positioned thereon, adopts the holding position, the robot hand 14 can move away from the holding device 114, initially along the longitudinal axis 128 of the support member 122. When the robot hand 14 is moved away from the holding device 114, the locking pin 32, which is positioned in the unlocking position, passes through the releasing structure 36 of the attachment member 26. At the same time, the holding biasing member 148 causes the holding member 118 to clamp the attachment member 26 between the holding member 118 and the holding stops 132 such that the attachment member 26 is securely held by the holding device 114.

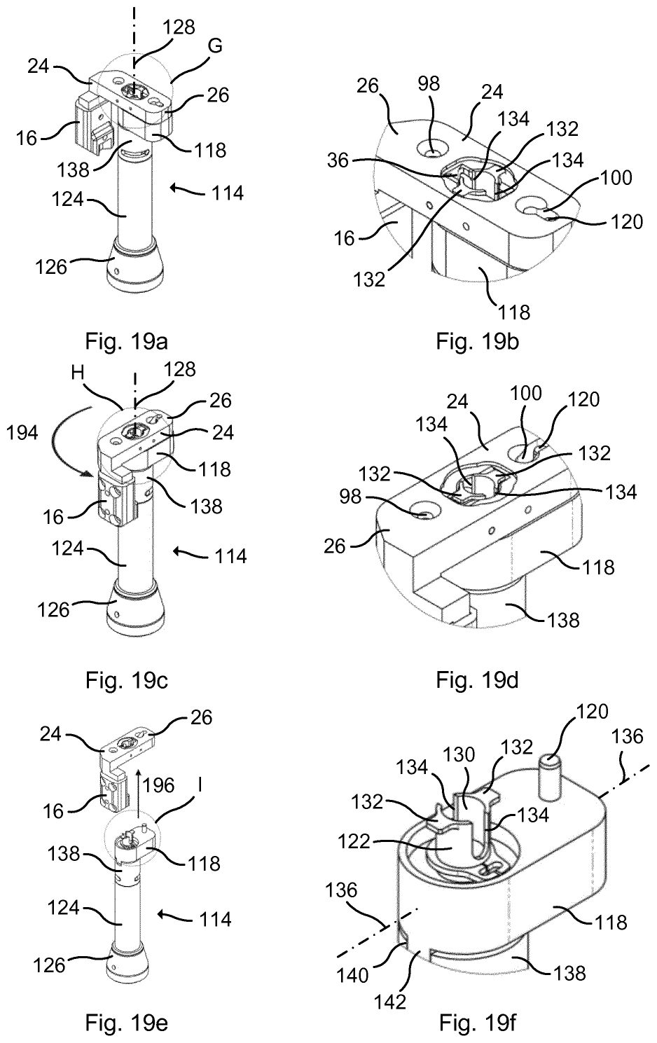

FIGS. 19a to 19f illustrate the reverse method, i.e. a method for detaching the gripper finger unit 24 from the holding device 114 and for attaching the gripper finger unit 24 to the robot hand 14. The robot hand 14 is omitted from these illustrations in order to improve visibility.

FIG. 19a shows the holding device 114 with the holding member 118 in the holding position and a gripper finger unit 24 held by the holding device 114. In FIG. 19b, which shows an enlarged view of portion G of FIG. 19a, it can be seen that the holding stops 132 grasp the attachment member 26 of the gripper finger unit 24 and that the locating pin 120 of the holding member 118 is received in the second positioning opening 100 of the attachment member 26.

FIG. 19e shows how the holding member 118 is rotated from the holding position in FIG. 19a into the releasing position in a rotational direction 194. FIG. 19d, which shows an enlarged view of portion H of FIG. 19c, shows that the rotation causes the holding stops 132 to become aligned with the releasing structure (not denoted) of the attachment member 26 and thereby no longer holds the attachment member 26.

FIG. 19e shows how the gripper finger unit 24 can be removed from the holding device 114 when the holding member 118 adopts the releasing position. The releasing direction of the gripper finger unit 24, which is parallel with the longitudinal axis 128 of the support member 122, is denoted 196. FIG. 19f, which shows an enlarged view of portion I in FIG. 19e, shows how the longitudinal axis 136 of the holding member 118 is aligned with the two holding stops 132 when the holding member 118 adopts the releasing position. The detachment of an attachment member 26 from the robot hand 14 and the attachment of an attachment member 26 to the robot hand 14 constitute an automatic quick change of an attachment member 26.

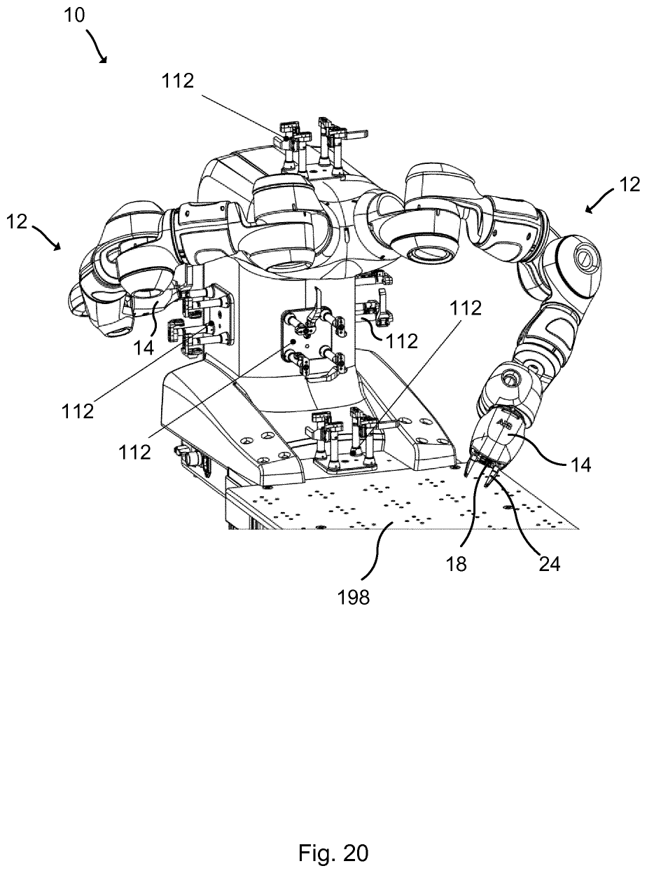

FIG. 20 schematically represents a perspective view of an industrial robot 10 comprising a plurality of holding systems 112. The industrial robot 10 of this example comprises five holding systems 112. Four holding systems 112 are attached to the body of the industrial robot 10 and one holding system 112 is arranged between the industrial robot 10 and a working table 198. Each holding system 112 comprises four holding devices (not denoted) according to the present disclosure.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. An attachment system for an industrial robot, the attachment system comprising:
a base member having a base and a locking member movable relative to the base between a locking position and an unlocking position; and
an attachment member;
wherein the attachment member includes an engageable structure configured to be engaged by the locking member when the locking member adopts the locking position, in order to fix the attachment member to the base member; and
wherein the attachment system further includes an engaging biasing member configured to bias the locking member towards the engageable structure, when the locking member engages the engageable structure in the locking position.

2. The attachment system according to claim 1, wherein the locking member is connected to the base such that the attachment member can be attached to the base member and detached from the base member without detaching the locking member from the base.

3. The attachment system according to claim 1, wherein the engageable structure is constituted by a cam profile.

4. The attachment system according to claim 1, wherein the attachment member comprises a releasing structure constituted by a through opening through which the locking member can pass when adopting the unlocking position, in order to attach the attachment member to the base member and in order to detach the attachment member from the base member.

5. The attachment system according to claim 1, wherein the movement of the locking member between the locking position and the unlocking position includes a rotational movement.

6. The attachment system according to claim 5, further comprising a rotation biasing member arranged to rotationally bias the locking member towards the unlocking position.

7. The attachment system according to claim 1, further comprising a gripper finger unit, wherein the gripper finger unit includes a gripper finger and the attachment member.

8. The attachment system according to claim 1, further comprising a positioning arrangement configured to unambiguously define a rotational relationship between the base member and the attachment member in an attachment position of the attachment member.

9. The attachment system according to claim 1, wherein the base member is configured to be fastened to a finger mounting plate of a robot hand of an industrial robot.

10. The attachment system according to claim 1, further comprising a tool configured to engage the locking member for manipulation of the locking member between the locking position and the unlocking position.

11. The attachment system according to claim 1, further comprising a holding device for releasably holding the attachment member, the holding device including:
a stationary support member including a longitudinal axis and at least one holding stop at one end of the support member;
a holding member rotatably arranged on the support member for rotation about the longitudinal axis of the support member between a holding position and a releasing position; and
a holding biasing member configured to bias the holding member towards the holding stop, such that a clamping interface for the attachment member is provided between the holding member and the holding stop, when the holding member adopts the holding position.

12. The attachment system according to claim 11, wherein the at least one holding stop is constituted by two holding stops, wherein each holding stop protrudes in substantially opposite directions perpendicular to the longitudinal axis of the support member and wherein a longitudinal axis of the holding member is substantially aligned with the two holding stops in the releasing position.

13. An industrial robot comprising an attachment system including:
a base member having a base and a locking member movable relative to the base between a locking position and an unlocking position; and
an attachment member;
wherein the attachment member includes an engagable structure configured to be engaged by the locking member when the locking member adopts the locking position, in order to fix the attachment member to the base member; and
wherein the attachment system further includes an engaging biasing member configured to bias the locking member towards the engageable structure, when the locking member engages the engageable structure in the locking position, and
wherein the industrial robot comprises a robot hand and wherein the attachment system is configured to detachably attach an end effector to the robot hand.

14. A method for handling an industrial robot comprising:
providing the robot hand with the base member;
providing the attachment member within reach of the robot hand;
moving the robot hand such that the locking member passes through a releasing structure of the attachment member and engages a stationary engaging structure;
moving the robot hand such that the locking member moves from the unlocking position to the locking position by means of the engagement with the engaging structure; and
biasing the locking member towards the engageable structure, in order to fix the attachment member to the base member.

15. The method according to claim 14, further comprising:
moving the robot hand, with the attachment member fixed to the base member, such that the locking member engages a stationary engaging structure;
moving the robot hand such that the locking member moves from the locking position to the unlocking position by means of the engagement with the engaging structure; and
moving the robot hand away from the engaging structure such that the locking member passes through the releasing structure of the attachment member.

16. The attachment system according to claim 2, wherein the engageable structure is constituted by a cam profile.

17. The attachment system according to claim 2, wherein the attachment member comprises a releasing structure constituted by a through opening through which the locking member can pass when adopting the unlocking position, in order to attach the attachment member to the base member and in order to detach the attachment member from the base member.

18. The attachment system according to claim 2, wherein the movement of the locking member between the locking position and the unlocking position includes a rotational movement.

19. The attachment system according to claim 2, further comprising a gripper finger unit, wherein the gripper finger unit includes a gripper finger and the attachment member.

20. The attachment system according to claim 2, further comprising a positioning arrangement configured to unambiguously define a rotational relationship between the base member and the attachment member in an attachment position of the attachment member.
